(19) United States
(12) Patent Application Publication
(10) Pub. No.: US 2019/0355077 A1
(43) Pub. Date: Nov. 21, 2019

(54) METHOD AND SYSTEM FOR REQUESTING SERVICE PROVIDERS IN REAL TIME

(71) Applicant: Mian Ahmed, Fremon, CA (US)

(72) Inventor: Mian Ahmed, Fremon, CA (US)

(21) Appl. No.: 16/526,050

(22) Filed: Jul. 30, 2019

Related U.S. Application Data
(63) Continuation-in-part of application No. 16/041,408, filed on Jul. 20, 2018.
(60) Provisional application No. 62/535,031, filed on Jul. 20, 2017.

(51) Int. Cl. G06Q 50/16; G06Q 30/02; G06Q 10/02; G06Q 30/06; G06F 16/29; H04N 5/232

(52) U.S. Cl. CPC G06Q 50/165; G06Q 30/0281; G06Q 10/02; H04N 5/23238; G06F 16/29; G06Q 30/0611; G06Q 30/0639

(57) ABSTRACT

A system and method for requesting service providers in real time. The system comprises a service request server and at least one database. The service request server is configured to enable a requestor such as customer to provide a request for service. The request includes type of service required and location where service is required. The server is further configured to display approved, authentic and qualified service providers matching the request provided by the requestor, within a particular area defined by the requestor. The server is further configured to provide a notification of the request to the service provider to accept or deny the request. The server is further configured to connect the service provider and the requestor on acceptance of the request. The server is further configured to process invoice on completion of service by the service provider.

### SEQUENCE LISTING OR PROGRAM

Not Applicable

### FEDERALLY SPONSORED RESEARCH

Not Applicable

### TECHNICAL FIELD OF THE PRESENT INVENTION

The present invention generally relates to customer service, and more specifically relates to a system and method for requesting service providers in real time.

### BACKGROUND OF THE PRESENT INVENTION

In present day, customers often encounter service repairs like plumbing, electrical, roofing, carpentry, heating and air, maids, handyman solutions, air conditioning, carpet cleaning, appliances, security, CCTV installation, cable and dish installation, furniture repair, landscaper, tree removal, pest control, or many other residential or commercial services. Conventional method employed to connect customers with service providers involves contacting the service provider through their mobile numbers and wait for their arrival, which comprises many drawbacks One problem is that many customers have hard time to get a licensed, insured, bonded, reliable, back ground checked, drug free service providers.

Another problem is that whenever the customer has an emergency break down they want the service provider arrive in no time and the service provider claim to be locally available few miles away from customer service location and create bogus appearance either on internet or print media using local numbers and inaccurate location because they are not local.

Another problem is that many service providers promise an arrival time with the customer but they don't arrive in that time frame and customer have no means to track when the service provider is arriving or even the service provider is in route or changed mind to not to even come. Hence there is no visibility or track where the service provider is.

Another problem is that the customers get surprised when upon arrival they come to know that the service provider who came to their service location after hours of waiting is hence not capable to do that job. The service provider or customer did not make clear what type of services customer need and if the service provider who is coming have expertise in performing those services.

Another problem is that most of the review sites don't show accurate reviews about service providers which makes customer confuse about their work ethics, because any one can create account and post un real reviews in favor of service providers. This makes customers to pick those service providers but after the service is performed in some cases the customer ends up in posting a negative feedback.

Another problem is that when the customers get a worse experience from a service provider there is no other service or system that block or prevent those service providers from appearing in front of other customers.

Another problem is that customers after encountering with an emergency break down don't know if the service provider they are choosing is even ready to fulfill that service request or not. There is no on-line status of the service provider if they are ready to work or not just a profile on-line doesn't mean a service provider is available.

Prior art US20170140323A1 of John Casey Laird et al. describes a system and method for facilitating communication sessions between consumers and service providers. The system is directed to receiving, from a consumer, a request for a product or service. The request is analyzed to determine one or more service providers that perform or provide the requested product or service. When various service providers are identified, an algorithm ranks the service providers from high to low. The highest ranked service provider is provided with an opportunity to instantly begin a communication with the consumer. If the highest ranked service provider declines, the next highest service provider is given the opportunity. However, the above patent reference only directed to determine service provider based on ranks and lacks to identify and connect with service providers based on estimated time of arrival, location, certifications. Further, the patent reference lacks to track the location of the service provider in real time and preferences to change schedule or cancel the provided service request.

Hence, it is necessary to provide customers with a system that would overcome customer's major objections like, getting service technicians estimated time of arrival, identify and connect with certified, licensed back ground checked service providers with true positive reviews, track service provider current location while service provider being driving and confirming that the service provider coming to customer location is fully capable of performing that work.

### Definitions

Unless stated to the contrary, for the purposes of the present the present invention teaches, the following terms shall have the following definitions:

The term “app” is a shortening of the term “application software”. It has become very popular and in 2010 was listed as “Word of the Year” by the American Dialect Society

“Apps” are usually available through application distribution platforms, which began appearing in 2008 and are typically operated by the owner of the mobile operating system. Some apps are free, while others must be bought. Usually, they are downloaded from the platform to a target device, but sometimes they can be downloaded to laptops or desktop computers.

“API”: In computer programming, an application programming interface API is a set of routines, protocols, and tools for building software applications. An API expresses a software module in terms of its operations, inputs, outputs, and underlying types. An API defines functionalities that are independent of their respective implementations, which allows definitions and implementations to vary without compromising each other. A good API makes it easier to develop a program by providing all the building blocks. A programmer then puts the blocks together. In addition to accessing databases or computer hardware, such as hard disk drives or video cards, an API can ease the work of programming GUI modules. For example, an API can facilitate integration of new features into existing applications a so-called “plug-in API”. An API can also assist otherwise distinct applications with sharing data, which can help to integrate and enhance the functionalities of the applications. APIs often come in the form of a library that includes specifications for routines, data structures, object classes, and variables. In other cases, notably SOAP and REST services, an API is simply a specification of remote calls exposed to the API consumers. An API specification can take many forms, including an International Standard, such as POSIX, vendor documentation, such as the Microsoft Windows API, or the libraries of a programming language, e.g., Standard Template Library in C++ or Java API.

“API Toolkit”: A toolkit is an assembly of tools; set of basic building units for user interfaces. An “API Toolkit” is therefore a set of basic building units for creating an application programming interface API.

Browser: a software program that runs on a client host and is used to request Pages and other data from server hosts. This data can be downloaded to the client's disk or displayed on the screen by the browser.

Client host: a computer that requests Pages from server hosts, and generally communicates through a browser program.

Content provider: a person responsible for providing the information that makes up a collection of Pages.

Electronic notification: any automated communication received by e-mail, phone, fax, text message, SMS, RSS or any third party software notification or alerting system.

“Electronic Mobile Device” is defined as any computer, phone, smartphone, tablet, or computing device that is comprised of a battery, display, circuit board, and processor that is capable of processing or executing software. Examples of electronic mobile devices are smartphones, laptop computers, and table PCs.

Embedded client software programs: software programs that comprise part of a Web site and that get downloaded into, and executed by, the browser.

“GUI”: In computing, a graphical user interface GUI sometimes pronounced “gooey” or “gee-you-eye” is a type of interface that allows users to interact with electronic devices through graphical icons and visual indicators such as secondary notation, as opposed to text-based interfaces, typed command labels or text navigation. GUIs were introduced in reaction to the perceived steep learning curve of command-line interfaces CLIs, which require commands to be typed on the keyboard.

Host: a computer that is connected to a network such as the Internet. Every host has a hostname e.g., mypc.mycompany.com and a numeric IP address e.g., 123.104.35.12.

HTML HyperText Markup Language: the language used to author Pages. In its raw form, HTML looks like normal text, interspersed with formatting commands. A browser's primary function is to read and render HTML.

HTTP HyperText Transfer Protocol: protocol used between a browser and a Web server to exchange Pages and other data over the Internet.

HyperText: text annotated with links to other Pages e.g., HTML.

Internet-Based Icon: a graphical or text icon that is linked to this system's database and enables the initiation of contact between the Advisor and the consumer, which is located anywhere throughout the Internet including but not limited to websites, emails, directory listings, and advertisement banners

IP Internet Protocol: the communication protocol governing the Internet.

An Internet service provider ISP is an organization that provides services for accessing, using, or participating in the Internet.

Server host: a computer on the Internet that hands out Pages through a Web server program.

A “mobile app” is a computer program designed to run on smartphones, tablet computers and other mobile devices, which the Applicant/Inventor refers to generically as “a computing device”, which is not intended to be all inclusive of all computers and mobile devices that are capable of executing software applications.

A “mobile device” is a generic term used to refer to a variety of devices that allow people to access data and information from where ever they are. This includes cell phones and other portable devices such as, but not limited to, PDAs, Pads, smartphones, and laptop computers.

A “module” in software is a part of a program. Programs are composed of one or more independently developed modules that are not combined until the program is linked. A single module can contain one or several routines or steps.

A “module” in hardware, is a self-contained module.

A “software application” is a program or group of programs designed for end users. Application software can be divided into two general classes: systems software and applications software. Systems software consists of low-level programs that interact with the computer at a very basic level. This includes operating systems, compilers, and utilities for managing computer resources. In contrast, applications software also called end-user programs includes database programs, word processors, and spreadsheets. Figuratively speaking, applications software sits on top of systems software because it is unable to run without the operating system and system utilities.

A “software module” is a file that contains instructions. “Module” implies a single executable file that is only a part of the application, such as a DLL. When referring to an entire program, the terms “application” and “software program” are typically used. A software module is defined as a series of process steps stored in an electronic memory of an electronic device and executed by the processor of an electronic device such as a computer, pad, smart phone, or other equivalent device known in the prior art.

A “software application module” is a program or group of programs designed for end users that contains one or more files that contains instructions to be executed by a computer or other equivalent device.

A “smartphone” or smart phone is a mobile phone with more advanced computing capability and connectivity than basic feature phones. Smartphones typically include the features of a phone with those of another popular consumer device, such as a personal digital assistant, a media player, a digital camera, and/or a GPS navigation unit. Later smart phones include all of those plus the features of a touchscreen computer, including web browsing, wideband network radio e.g. LTE, Wi-Fi, 3rd-party apps, wireless motion sensor and mobile payment.

A “User” is any person using the computer system executing the method of the present invention.

URL Uniform Resource Locator: the address of a Web module or other data. The URL identifies the protocol used to communicate with the server host, the IP address of the server host, and the location of the requested data on the server host.

A “web application” or “web app” is any application software that runs in a web browser and is created in a browser-supported programming language such as the combination of JavaScript, HTML and CSS and relies on a web browser to render the application.

A “website”, also written as Web site, web site, or simply site, is a collection of related web pages containing images, videos or other digital assets. A website is hosted on at least one web server, accessible via a network such as the Internet or a private local area network through an Internet address known as a Uniform Resource Locator URL. All publicly accessible websites collectively constitute the World Wide Web.

Web master: the person in charge of keeping a host server and Web server program running.

A “web page”, also written as webpage is a document, typically written in plain text interspersed with formatting instructions of Hypertext Markup Language HTML, XHTML. A web page may incorporate elements from other websites with suitable markup anchors.

Web page: multimedia information on a Web site. A Web page is an HTML document comprising other Web modules, such as images.

The “Web pages” are accessed and transported with the Hypertext Transfer Protocol HTTP, which may optionally employ encryption HTTP Secure, HTTPS to provide security and privacy for the user of the web page content. The user's application, often a web browser displayed on a computer, renders the page content according to its HTML markup instructions onto a display terminal. The pages of a website can usually be accessed from a simple Uniform Resource Locator URL called the homepage. The URLs of the pages organize them into a hierarchy, although hyperlinking between them conveys the reader's perceived site structure and guides the reader's navigation of the site.

Web server: a software program running on a server host, for handing out Pages.

Web site: a collection of Pages residing on one or multiple server hosts and accessible through the same hostname such as, for example, www.topleveldomian.com.

### SUMMARY OF THE PRESENT INVENTION

The present invention teaches a system and method to identify and acquire assistance of a local, clean, professional, real, experienced, service providers in real time.

One aspect of the present invention includes a cloud, wireless, wide area, wired network system architecture. Another aspect of the present invention includes the method for initiating and accepting service request via the cloud, wireless network. Another aspect of the present invention includes the method of confirming the availability of service providers via cloud, wireless, wide area network. Another aspect of the present invention includes a method of displaying approved, authentic, qualified service providers in real time within defined radius. Another aspect of invention includes the method of displaying the closest service provider to the service location based upon the performance from a given preference list. Another aspect of the present invention includes the method to locate the service provider exactly according to customer search where the request broadcasts to the defined no of service providers on remote or wired devices via cloud, wireless, wired network system.

Another aspect of the present invention includes the method for accepting the service request by set of available and ready service provider within the required time where if no service provider accepts the service request it moves on to next set of service providers. Another aspect of invention includes the real-time travel display the route time calculation through a track or a route display along with the time of arrival of service provider. Another aspect of invention includes the method of displaying most efficient and quickest route to customer and service provider the same real-time drive route is displayed on customer and service provider devices. Another aspect of the present invention includes the feedback process where only the customers who received service can rate the service providers not even other customers on same system can rate a service provider until they request a service not any other user can rate any service provider.

Other objects, features and advantages of the present invention will become apparent from the following detailed description. It should be understood, however, that the detailed description and the specific examples, while indicating specific embodiments of the present invention, are given by way of illustration only, since various changes and modifications within the spirit and scope of the present invention will become apparent to those skilled in the art from this detailed description.

### BRIEF DESCRIPTION OF THE DRAWINGS

The accompanying drawings, which are incorporated herein and form a part of the specification, illustrate the present invention and, together with the description, further serve to explain the principles of the present invention and to enable a person skilled in the pertinent art to make and use the present invention.

The embodiments herein will be better understood from the following detailed description with reference to the drawings, in which:

FIG. 1 exemplarily illustrates an environment implemented in accordance with various embodiments of the present invention.

FIG. 2 exemplarily illustrates a block diagram of a service request server, according to an embodiment of the present invention.

FIG. 3 exemplarily illustrates a method for requesting service providers in real time, according to an embodiment of the present invention.

FIG. 4 exemplarily illustrates a process flow of the customer, according to an embodiment of the present invention.

FIG. 5 exemplarily illustrates a process flow of the service provider, according to an embodiment of the present invention.

FIG. 6 exemplarily illustrates a process flow of the service provider associated with a company, according to an embodiment of the present invention.

### DETAILED DESCRIPTION OF THE PRESENT INVENTION

A description of embodiments of the present invention will now be given with reference to the Figures. It is expected that the present invention may be embodied in other specific forms without departing from its spirit or essential characteristics. The described embodiments are to be considered in all respects only as illustrative and not restrictive. The scope of the present invention is, therefore, indicated by the appended claims rather than by the foregoing description. All changes that come within the meaning and range of equivalency of the claims are to be embraced within their scope.

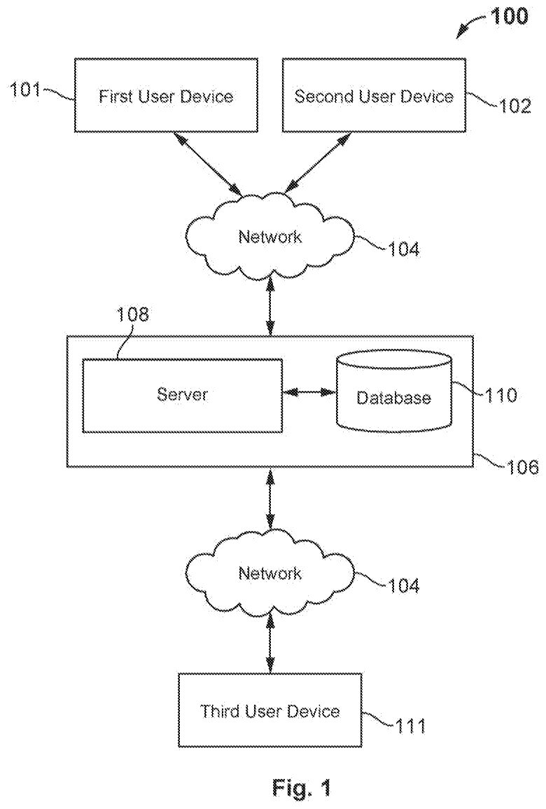

The present invention discloses a system and method for requesting a service provider in real time. The system enables a requestor such as a customer or a user requiring service providers to connect with a preferred service provider. Referring to FIG. 1, a block diagram of an environment 100 implemented in accordance with various embodiments of the present invention is disclosed. The environment 100 comprises a first user device 101 associated with a first user, a second user device 102 associated with a second user, a third user device 111 associated with a third user, a network 104, and a web-based service request system 106 connecting service provider with the customer. In an embodiment, the service request system 106 comprises a service request server 108 and at least one database 110.

In an embodiment, the first user device 101, second user device 102 and third user device 11 are enabled to access the service request system 106 via the network 104. In an embodiment, the first user is a customer or a requestor requiring service. In an embodiment, the second user is a service provider or technician providing service. In an embodiment, the third user is a company operated service provider or service provider associated with the company. In one embodiment, the service request server 108 is configured to enable the requestor to provide a request for service. The request includes type of service required and location where service is required. The server 108 is further configured to display approved, authentic and qualified service providers matching the request provided by the requestor, within a particular area defined by the requestor. The server 108 is further configured to provide a notification of the request to accept or deny the request. The server 108 is further configured to connect the service provider and the requestor on acceptance of the request. The server 108 is further configured to process invoice on completion of service by the service provider.

In an embodiment, the user device (101, 102, 111) is in communication with the network 104 to access the service request server 108. In an embodiment, the network 104 could be Wi-Fi network, WiMax network, and wireless local area network. In one embodiment, the user device (101, 102, 111) is at least anyone of a desktop, a laptop, a tablet, a mobile phone, mobile and/or handheld electronic devices, personnel digital assistants, smart phones, smart televisions, palm tops and phablets.

In one embodiment, the at least one database 110 may be accessible by the service request server. The database 110 may be integrated into the service request server or separate from it. In some embodiments, the database 110 resides in a connected server or in a cloud computing service. Regardless of location, the database 110 comprises a memory to store and organize certain data for use by the service request server 108. In some embodiments, the database 110 stores information relating to a customer, service provider and company operated service provider. The database 110 comprises information to identify the customer, service provider and the company, types of service such as plumbing, electrical, roofing, carpentry, heating and air, maids, handyman solutions, air conditioning, carpet cleaning, appliances, security, CCTV installation, cable and dish installation, furniture repair, landscaper, tree removal, pest control, and other residential and commercial services, map data and payment data.

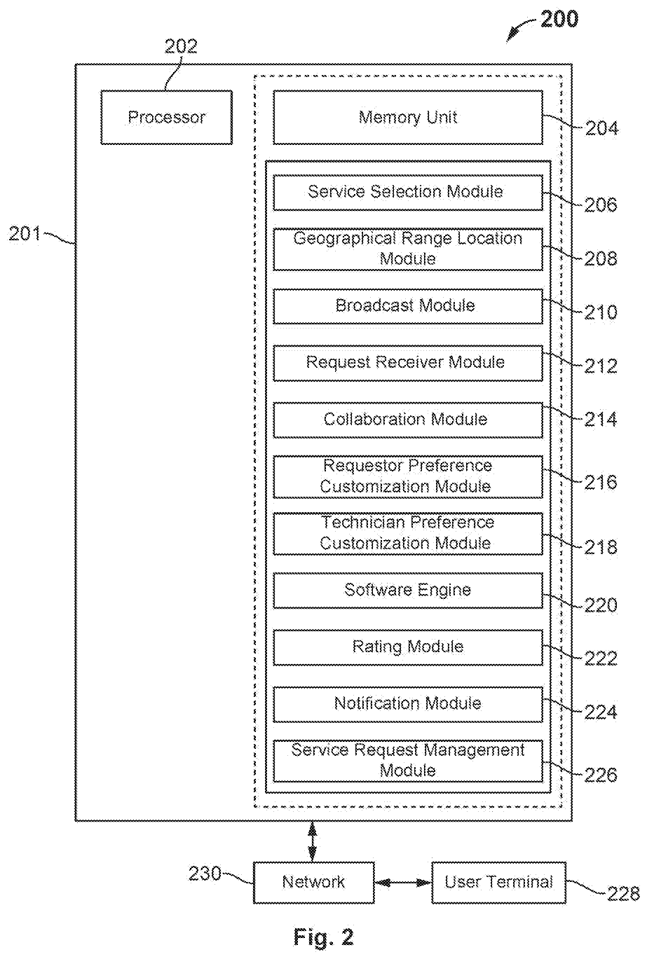

In one embodiment, the service request server 108 is at least one of a general or special purpose computer. The service request server 108 could be operated as a single computer, which can be a hardware and/or software server, a workstation, a desktop, a laptop, a tablet, a mobile phone, a mainframe, a supercomputer, a server farm, and so forth. In some embodiments, the computer could be touchscreen and/or non-touchscreen and adopted to run on any type of OS, such as iOS™, Windows™, Android™, Unix™, Linux™ and/or others. In one embodiment, the plurality of computers is in communication with each other, via networks. Such communication can be via a software application, a mobile app, a browser, an OS, and/or any combination thereof. Further, a block diagram 200 of an exemplary implementation of the service request server (108 or 201) is illustrated in FIG. 2.

FIG. 2 is a block diagram 200 of the service request server 201 in an embodiment of the present invention. The server 201 comprises a processor 202 and a memory unit 204. The memory unit 206 comprises a set of program modules comprises a service selection module 206, a geographical range location module 208, a broadcast module 210, a request receiver module 212, a collaboration module 214, a requestor preference a customization module 216, a technician preference customization module 218, a software engine 220 and a rating module 222.

In one embodiment, a user access server 201 via a user terminal 228 via a network 230. In some embodiments, the network 230 is at least anyone of a Wi-Fi network, WiMax network, and wireless local area network. In some embodiments, the user terminal 228 is at least anyone of a desktop, a laptop, a tablet, a mobile phone, mobile and/or handheld electronic devices, personnel digital assistants, smart phones, smart televisions, palm tops and phablets. In an embodiment, the user is requestor or customer, service provider or service technician, or service provider associated with the company.

In one embodiment, the server 201 is configured to connect service provider and customer in real time. The service selection module 206, executed by the processor 202, is configured to enable the requestor to provide a request for a service, wherein the request includes a type of service required, preferred service technician, date, and time, and customer specified location where the service need to be performed. Further, the service selection module 206 is configured to enable the requestor to select preferences such as licensed service provider, insured service provider, bonded service provider, certified service provider, or screened service provider or service provider without license. In one embodiment, the system further provides details of the service provider such as number of service provider in the requestor specified location, estimated time of arrival (ETA) of the service provider and distance between the service provider and the requestor before selection of the request. In another embodiment, the system enables the requestor to

The geographical range location module 208, executed by the processor 202, is configured to locate one or more service provider matching the request provided by the requestor within a particular area relative to the preferred location. The server 201 starts searching the appropriate service provider and finds exact match using customer provided information. In one embodiment, one or more service provider includes a company operated service providers.

The broadcast module 210 in communication with the geographical range location module 208, executed by the processor 202, is configured to broadcast the request to the one or more service provider for specific period of time. The request receiver module 212, executed by the processor 202, is configured to present or display the broadcasted request to the service provider to accept or to deny the request for a specific period of time. The request receiver module 212 is further configured to enable the service technician to accept at least one service request before finishing the ongoing service request.

In one embodiment, if one or more service provider identified is a company operated service providers, the request receiver module 212 displays the service request on company dashboard through software engine 220 for a set defined time to accept or reject the request. If no service provider accepts the service request, the geographical range location module 208 would locate a next set of defined service providers based on the request of the customer and broadcasts the service request via the broadcast module 210. This process continues until any one service provider accepts that service request.

On acceptance of the request, the collaboration module 214, executed by the processor 202, is configured to connect the service provider and the requestor. Further, the geographical range location module 208 in communication with the collaboration module 214 is configured to creates a real-time drive route from the service provider current location to the customer service location. Further, the geographical range location module 208 is configured to notify the customer about the service provider being in route along with service provider's estimated time of arrival. In one embodiment, the service provider on acceptance of the request, the service provider or she could drive to service location on his or will, which provides the time to clear any ongoing call of the service provider. The server 201 is configured to send notification to the customer via the notification module 224, about which service provider accepted request and gets another notification when service provider gets en-route with the route and drive line on map. The rating module 222, executed by the processor 202, is configured to enable the customer to rate the service provider work confirming the service completion. The software engine 220, executed by the processor 202, is configured to process invoice for the service provided by the service provider.

The requestor preference customization module 216, executed by the processor 202, is configured to enable the requestor to set a first criterion to automatically receive notification respective of one or more service technician on satisfaction of the set first criterion, wherein the first criterion includes preferred month, day, time and location. For example, if the requestor sets a specific day and time of the month, and if any service provider enters into a location relation to the location specified by the requestor on set time, day of the month, then the server 201 sends notification to the customer about the number of service provider, ETA and distance between the service provider and the requestor specified service location.

The requestor preference customization module 216, executed by the processor 202, is further configured to enable the requestor to set a second criterion to automatically receive notification of one or more service technician on satisfaction of the set second criterion, wherein the second criterion includes preferred service technician and location of the preferred service technician for example, if his or her preferred pro or the one who worked in his/her house in past is in neighborhood or nearby his house, the server automatically send service request to the service provider. If the service provider accepts the request, the system would connect the requestor and the service provider for further proceedings.

The requestor preference customization module 216, executed by the processor 202, is further configured to enable the requestor to set a third criterion to automatically receive notification of one or more service technician on satisfaction of the set third criterion, wherein the third criterion includes preferred types of service the service provider/she wants in future. For example, when the service provider belonging or linked to that particular one or more services enters in the customers neighborhood or set radius of customer specified service location, the server 201 will send the push notification to customer about those service providers being nearby. Then, the customer could connect with the service provide in neighborhood, this could save them a huge time for not waiting someone in any other time and have someone come at same time.

The service request management module 226, executed by the processor 202, is configured to enable the requestor or service provider to cancel or reschedule the service request while being in-route or during driving. If the requestor reschedules the time, the service provider would receive details of reschedule via a notification module 224. The service provider either could accept the service request or reply back with other time or date based on his or her availability. The response of the service provider is sent to the requestor via the notification module 224.

The technician preference customization module 218, executed by the processor 202, is configured to enable the service provider to set preferences to automatically send notification to one or more requestor on entering a particular location. For example, if the service provider enters a particular city or zip code, the server tracks his or her latitude and longitude and send push notifications automatically to customers who want same related services.

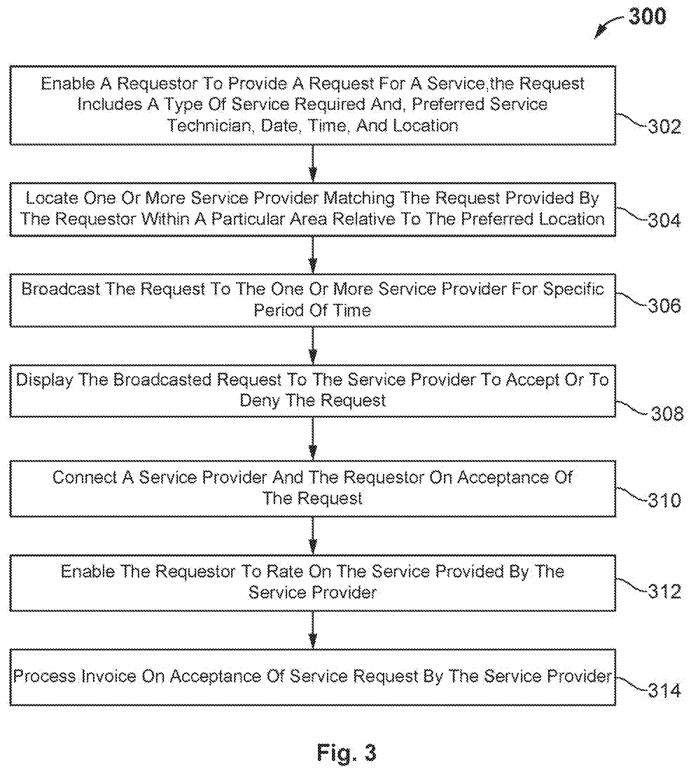

Referring to FIG. 3, a web-based method 300 for requesting service provider in real time is illustrated. In one embodiment, the method 300 is incorporated in the system comprising a server with a processor and a memory unit, a database in communication with the server for storing information related to the service provider, the customer and map data, and a first user device and a second user device configured to access the server via a network. At step 302, the method 300 includes, enabling at the processor, via a service selection module, a requestor to provide a request for a service, wherein the request includes a type of service required and, preferred service technician, date, time, and location. At step 304, the method 300 includes, locating at the processor, via a geographical range location module, one or more service provider matching the request provided by the requestor within a particular area relative to the preferred location.

At step 306, the method 300 includes, broadcasting at the processor, via a broadcast module in communication with the geographical range location module, the request to the one or more service provider for specific period of time. At step 308, the method 300 includes, displaying at the processor, via a request receiver module, the broadcasted request to the service provider for acceptance or to deny the request. At step 310, the method 300 includes, connecting at a processor, via a collaboration module, the service provider and the requestor on acceptance of the request. At step 312, the method 300 includes, enabling at the processor, via a rating module, the requestor to rate on the service provided by the service provider. At step 314, the method 300 includes, processing at the processor, via a software engine, invoice for the service provided by the service provider.

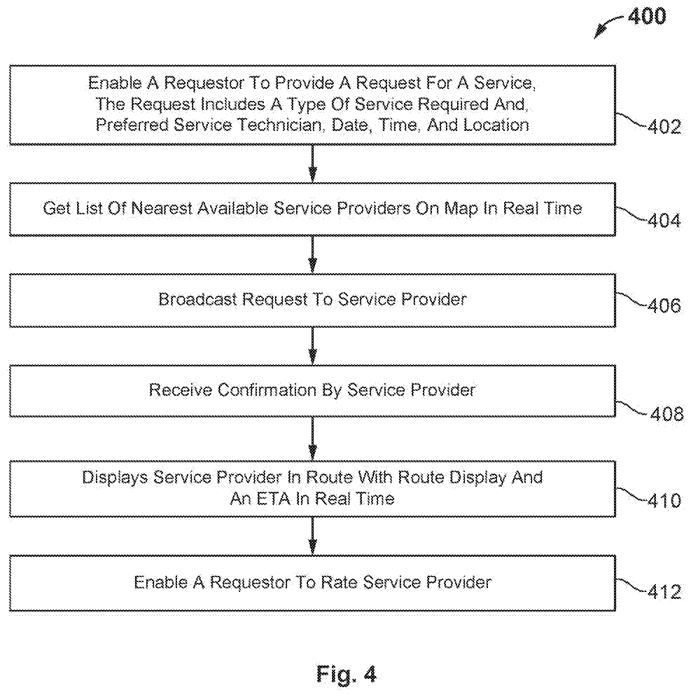

Referring to FIG. 4, a process flow 400 of the customer is illustrated. At step 402, the requestor is enabled to provide a request for a service, the request includes a type of service required and, preferred service technician, date, time, and location. At step 404, a list of nearest available service providers is displayed to the requestor in real time. At step 406, the request is broadcasted to the list of service provider. At step 408, the requestor receives confirmation from at least one service provider. At step 410, the service provider in route with route display and an ETA in real time is displayed to the requestor. At step 412, the requestor is enabled to rate the service provider.

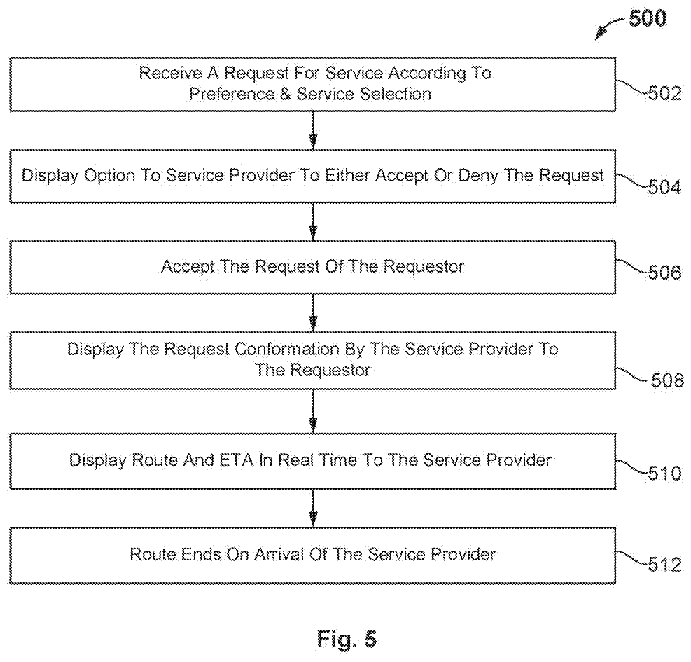

Referring to FIG. 5, a process flow 500 of the service provider is illustrated. At step 502, the service provider receives a request for service according to preference & service selection. At step 504, option to either accept or deny the request is displayed to the service provider. At step 506, the service provider accepts the request. At step 508, the configuration of the request is displayed to the requestor. At step 510, the route and ETA are displayed in real time to the service provider. At step 512, the route ends on arrival of the service provider to the customer specified location.

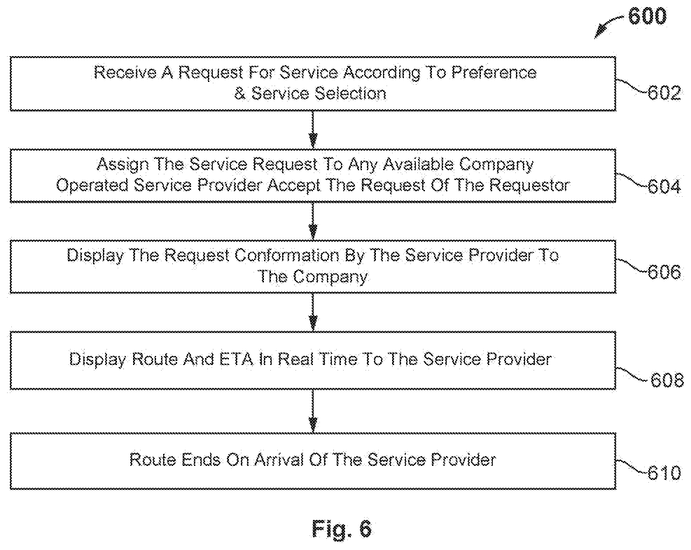

Referring to FIG. 6, a process flow 600 of the service provider associated with a company is illustrated. At step 602, the company receives a request for service according to preference & service selection. At step 604, company assigns the service request to any available company operated service provider accept the request of the requestor. At step 606, the configuration of the request is displayed to the requestor. At step 608, route and ETA are displayed in real time to the service provider. At step 610, the route ends on arrival of the service provider to the customer specified location.

Although a single embodiment of the present invention has been illustrated in the accompanying drawings and described in the above detailed description, it will be understood that the present invention is not limited to the embodiment developed herein, but is capable of numerous rearrangements, modifications, substitutions of parts and elements without departing from the spirit and scope of the present invention.

The foregoing description comprises illustrative embodiments of the present invention. Having thus described exemplary embodiments of the present invention, it should be noted by those skilled in the art that the within the present invention teaches are exemplary only, and that various other alternatives, adaptations, and modifications may be made within the scope of the present invention. Merely listing or numbering the steps of a method in a certain order does not constitute any limitation on the order of the steps of that method. Many modifications and other embodiments of the present invention will come to mind to one skilled in the art to which this invention pertains having the benefit of the teachings presented in the foregoing descriptions. Although specific terms may be employed herein, they are used only in generic and descriptive sense and not for purposes of limitation. Accordingly, the present invention is not limited to the specific embodiments illustrated herein.

### Proximity Alert Embodiment

The present invention teaches a system and method to notify the on line and offline users of the system about available or becoming available service providers within the proximity of homeowners to identify and acquire assistance of a local, clean, professional, real, experienced, service providers in real time.

One aspect of the present invention includes a cloud, wireless, wide area, wired network system architecture. Another aspect of the present invention includes the method and system displaying one or more service professionals/service providers within the homeowners neighborhood, proximity in real time.

The system works in the way that servers, combination of servers, data bases, rams, processors, systems in cloud and other related infrastructure reads the latitude and longitude of all service providers and reads the zip code from the defined data base within the set radius and matches only those service providers who are available or have entered in that radius. Once the number of service providers are matched with the set radius within the homeowner zip codes the system then displays those service providers on homeowner mobile devices, remote devices, computers, tablets and so on.

Another aspect of the present invention includes a system and method of notifying the presence of the service professionals to homeowners in their proximity. The system works with the combination of wired network, wireless network, wide area network, cloud, remote network, processors, motherboards, CPU, data bases, ram, SAAS system to notify the homeowners about the presence of the matched, top rated, back ground checked, screened, service professionals in real time.

The system further displays the presence of service providers on GOOGLE maps on homeowners mobile devices, remote devices, computer, tablets and other map supported devices. Another aspect of the present invention includes the system and method to display the distance of the service providers from the homeowners once they are in their proximity. Another aspect of the present invention includes the system and method to display the total number of service providers present within the proximity of home owners on home owners mobile devices, remote devices, computer devices, tablets and other related devices.

Another aspect of the present invention includes the system and method to display the “ETA” or estimated time of arrival of the service providers once they are in the homeowners of proximity. The ETA is displayed on homeowners and service providers mobile devices, remote devices, computers, tablets and all other devices.

Another aspect of the present invention includes system and method to reserve the service appointment with service professionals once one or more service professional is in homeowners proximity in real time. The system works with the combination of wired network, wireless network, wide area network, cloud, remote network, processors, motherboards, CPU, data bases, ram, SAAS system to create and reserve the home improvement or service repair appointment with service providers once they are in the homeowner proximity. Once the homeowners gets notified about the presence of service providers in their proximity they get the option to reserve the service appointment with one service provider.

The service provider once get free is notified about the homeowner in their proximity reserved service request and the service provider gets an option to accept and deny the service request. Another aspect of the present invention includes the system and method to pass the unaccepted service request in the que and system then displays that service request from the que to other service providers within the proximity of homeowners once they become available.

Another aspect of invention includes the method and system of notifying the homeowners about the presence of their favorite service professional or the service professional who served them in the past once the service provider or they are in their proximity. The system works with the combination of wired network, wireless network, wide area network, cloud, remote network, processors, motherboards, CPU, data bases, ram, SAAS system to first give option to the homeowner to add a service provider who served them in to favorites section of the homeowner app or web portal.

Once the same service provider comes within their proximity, they are notified about the presence of their favorite service provider. Another aspect of invention includes the method and system to reserve the services with favorite service providers once they are in the homeowners proximity and become available. The favorited service provider would finally get notified by the homeowner who got their services in the past. The service request stays in que and no one gets notified about that service request but only that favorite service provider once the service provider or they get available within home owners proximity. Once the service provider accepts the service request, the service provider gets in contact with homeowner and gets routed to homeowner. Another aspect of invention includes the method and system to reserve the services with favorited service providers in advance even when they are not in homeowner proximity. The system creates and reserves the homeowner created service request in the que until the favorite service provider comes within the homeowners proximity. Once in proximity the service provider gets notified about the in que service request.

Another aspect of the present invention includes the method and system allowing the homeowners to reserve the service appointment In advance with any service professionals once they are in homeowners proximity notifying the service professionals about the service requests once available in their proximity and notifies back the homeowners about the available service professionals in their proximity along with the notification once service request is accepted.

The system works with the combination of wired network, wireless network, wide area network, cloud, remote network, processors, motherboards, CPU, data bases, ram, SAAS system to let homeowner create a service request in advance for any service provider. Once the homeowner creates the service request its placed in que until a service provider comes within proximity of homeowner. Once a service provider is in the proximity of home owner the service request is broadcasted and any service provider who now is in proximity of homeowner and second is available, matched to home owner service request preferences is notified. The service provider have options to accept or deny the service request. The service request goes to all matched, available service providers within a homeowners proximity.

Another aspect of the present invention includes the method and system that creates a service needed notifier once the service provider comes in homeowner proximity. The system will automatically broadcast in app and push notifications on homeowner mobile, remote, desktop, tablets and other online devices that a service provider is in homeowner proximity within defined radius for a limited time period. The homeowners can reserve a spot by creating and scheduling a service request for future service or for the time when any one or more service providers get free within the homeowner proximity and set radius

The system works with the combination of wired network, wireless network, wide area network, cloud, remote network, processors, motherboards, CPU, data bases, ram, SAAS system to complete this entire process.

### Up for Bid Embodiment

In an alternative embodiment, the present invention teaches a system and method to create a home improvement, repairs, replacement, new addition, new build, residential or commercial project bid process in real time.

One aspect of the present invention includes a cloud, wireless, wide area, wired network system architecture. Another aspect of the present invention includes the method and system to create the residential or commercial project bid process where homeowner or customers creates a project with the specific information, requirements, project details, project images, and other project related information. The homeowner then picks the bid duration time. The homeowner then adds important requirements proceeds to post the project for bid.

Another aspect of the present invention includes the method and system to create the home improvement, renovation, new build project with capability to post 360 degree panoramic images of the project, where the project is going to be happen, what aspect of the project need to be done and so on. The in app 360 degree panoramic camera functionality built in the mobile app works in the way that when user initiates the image or video recorder the camera first sets 360 degree angle once angle is set the application lets the user know to move in a circle in either one direction. The camera is then moved in rotation starting one point in a circle and coming back to same point same way to opposite direction or in other words the camera is started moving from one fix point and bringing back to same start point. The another aspect of the present invention includes the method and system to create marks, text and edits on the 360 deg capture to explain where the repairs or replacement is required to be done.

Another aspect of the present invention includes the method and system to start the bid process for home improvement, by setting up a time to start and end the bid. The service professionals/contractors would get in app and push notifications about when homeowner posts a project for bid. The project with all details publish and appears on GOOGLE maps on all devices such as mobile devices, desktop, cell phones, PDA devices, iPad, tablets and cloud devices. The service provider when access the project it appears to be locked and they have to unlock to get full access to the project.

Another aspect of the present invention includes the method and system in the way that the bid starts with a minimum amount that the homeowner is willing to spent on the project. The bidders won't be able to see the other bidders bid the bid displays the lowest value of the bid to the highest value in a leveled graph and chart. Only the one who created the project would be able to see the entire bid score. The lowest bidder being the winner and highest bidder being not the winner.

The service providers or bidders would be able to see the number of bidders bidding on same project. The bidders would also get the in app and push notification about someone unknown becoming higher bidder then them with disclosing the outbid amount. The bidder cant increase the bid but can decrease the bid amount. The bidders will have only one chance to enter the bid amount. Only the bidder would be able to see his bid amount. No other bidder would see the other bidders bid amount. Once the bidder enter in bidding and placed a bid they can't back out and the bid amount they entered would stay in place.

Another aspect of the present invention includes the method and system not to display the current bid amount in real time. Once the bidder is outbid by other bidder the new bid amount updates instantly and in real time to homeowner and all bidders bidding on that project gets notification about they being out bided by someone. The service providers can update their bid to stay above the other bidders. The homeowners and bidders get the in-app and push notification and all other means of notifications about the current status of bid, any new activity happens on bid in real time.

Another aspect of the present invention includes the method and system to create or post home improvement projects for a fixed or a variable price offer. Another aspect of the system includes the method and system where customer or homeowner creates the project with an offer only option which means that one or more service professionals can submit an offer for the project. The homeowner can either, accept, deny or counter the desired offer for the project. Same way the service professional can either accept, deny or counter the homeowner project offer.

The system will set the homeowners project for a certain time and after the time passes the project either ends or resets with all same terms on its self. Another aspect of the present invention includes the method and system to pick the offer expiration time and date before submitting the offer. Another aspect of the present invention includes the method and system to send in app and push notifications to homeowner, service professionals about the changes made to offer, when it expires, how many other bidders are watching and showing interest to same project.

The method of the present invention is set to run on a computing device. A computing device on which the present invention can run would be comprised of a CPU, Hard Disk Drive, Keyboard, Monitor, CPU Main Memory and a portion of main memory where the system resides and executes. Any general-purpose computer with an appropriate amount of storage space is suitable for this purpose. Computer Devices like this are well known in the art and are not pertinent to the present invention. The method of the present invention can also be written in a number of different software languages and run on a number of different operating systems and platforms.

Although the present invention has been described in considerable detail with reference to certain preferred versions thereof, other versions are possible. Therefore, the point and scope of the appended claims should not be limited to the description of the preferred versions contained herein.

As to a further discussion of the manner of usage and operation of the present invention, the same should be apparent from the above description. Accordingly, no further discussion relating to the manner of usage and operation will be provided.

With respect to the above description, it is to be realized that the optimum dimensional relationships for the parts of the present invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the present invention. Further, since numerous modifications and changes will readily occur to those skilled in the art, it is not desired to limit the present invention to the exact construction and operation shown and described, and accordingly, all suitable modifications and equivalents may be resorted to, falling within the scope of the present invention.

The embodiments of the present invention in which an exclusive property or privilege is claimed are defined as follows:

1. A system for requesting service provider in real time, comprising
a server comprising a processor and a memory unit;
a cloud, wireless, wide area, and wired network system architecture;
a database in communication with the server for storing information related to the service provider, the requestor and map data;
a first user device associated with a requestor configured to access the server via a network, and
a second user device associated with a service provider configured to access the server via a network, wherein the memory unit stores a set of program modules, and
wherein the processor in communication with the memory unit, configured to execute the set of program modules, wherein the set of program modules comprises,
a service selection module configured to enable a requestor to provide a request for a service, wherein the request includes a type of service required and, preferred service provider, date, time, and location,
a geographical range location module configured to locate one or more service provider matching the request provided by the requestor within a particular area relative to the preferred location,
a broadcast module in communication with the geographical range location module configured to broadcast the request to the one or more service provider for a predefined time,
a request receiver module configured to display the broadcasted request to the service provider to accept or deny the request,
a collaboration module configured to connect a service provider and the requestor on acceptance of the request,
a rating module configured to enable the requestor to rate on the service provided by the service provider, and
a software engine is configured to process invoice for the service provided by the service provider; and
notifying the on line and offline users of the system about available or becoming available service providers within the proximity of homeowners to identify and acquire assistance of local service providers in real time.

2. The system of claim 1, wherein
the collaboration module in communication with the geographical range location module configured to provide a route to the service provider in real time to reach the location specified by the requestor; and
the servers, combination of servers, databases, rams, processors, systems in cloud and other related infrastructure reads the latitude and longitude of all service providers and reads the zip code from the defined data base within the set radius and matches only those service providers who are available or have entered in that radius;
once the number of service providers are matched with the set radius within the homeowner zip codes the system then displays those service providers on homeowner mobile devices, remote devices, computers, tablets.

3. The system of claim 2, wherein
the system displays the presence of service providers on maps on homeowners mobile devices, remote devices, computer, tablets and other map supported devices;
displaying the distance of the service providers from the homeowners once they are in their proximity;
displaying the total number of service providers present within the proximity of home owners on home owners mobile devices, remote devices, computer devices, tablets and other related devices; and
displaying the “ETA” or estimated time of arrival of the service providers once they are in the homeowners of proximity.

4. The system of claim 3, wherein
to reserve the service appointment with service professionals once one or more service professional is in homeowners proximity in real time;
create and reserve the home improvement or service repair appointment with service providers once they are in the homeowner proximity; and
once the homeowners gets notified about the presence of service providers in their proximity they get the option to reserve the service appointment with one service provider.

5. The system of claim 4, wherein
the service provider is notified about the homeowner in their proximity reserved service request and the service provider gets an option to accept and deny the service request;
any unaccepted service request in the que is then displayed to other service providers within the proximity of homeowners once they become available.

6. The system of claim 2, wherein
the homeowners are notified about the presence of their favorite service professional or the service professional who served them in the past once the service provider or they are in their proximity; and
homeowners are given the opportunity to add a service provider who served them in to a favorites section of the homeowner app or web portal.

7. The system of claim 6, wherein
once the same service provider comes within their proximity, homeowners are notified about the presence of their favorite service provider;
homeowners may reserve the services with favorite service providers once they are in the homeowners proximity and become available;
the favorited service provider would finally get notified by the homeowner who got their services in the past; and
the service request stays in que and no one gets notified about that service request but only that favorite service provider once the service provider or they get available within home owners proximity; and
once the service provider accepts the service request, the service provider gets in contact with homeowner and gets routed to homeowner.

8. The system of claim 7, wherein
to reserve the services with favorited service providers in advance even when they are not in homeowner proximity, the system creates and reserves the homeowner created service request in the que until the favorite service provider comes within the homeowners proximity; and
once in proximity the service provider gets notified about the in que service request.

9. The system of claim 7, wherein
allowing the homeowners to reserve the service appointment in advance with any service professionals once they are in homeowners proximity; and
notifying the service professionals about the service requests once available in their proximity and notifies back the homeowners about the available service professionals in their proximity along with the notification once service request is accepted.

10. The system of claim 1, wherein
the homeowner creates a service request in advance for any service provider;
once the homeowner creates the service request its placed in que until a service provider comes within proximity of homeowner;
once a service provider is in the proximity of home owner the service request is broadcasted and any service provider who now is in proximity of homeowner and second is available, matched to home owner service request preferences is notified;
the service provider have options to accept or deny the service request; and
the service request goes to all matched, available service providers within a homeowners proximity.

12. The system of claim 1, wherein
creates a service needed notifier once the service provider comes in homeowner proximity;
automatically broadcast via in app and push notifications on homeowner mobile, remote, desktop, tablets and other online devices that a service provider is in homeowner proximity within defined radius for a limited time period; and
the homeowners can reserve a spot by creating and scheduling a service request for future service or for the time when any one or more service providers get free within the homeowner proximity and set radius

13. A system for requesting service provider in real time, comprising
a server comprising a processor and a memory unit;
a cloud, wireless, wide area, and wired network system architecture;
a database in communication with the server for storing information related to the service provider, the requestor and map data;
a first user device associated with a requestor configured to access the server via a network, and
a second user device associated with a service provider configured to access the server via a network, wherein the memory unit stores a set of program modules, and
wherein the processor in communication with the memory unit, configured to execute the set of program modules, wherein the set of program modules comprises,
a service selection module configured to enable a requestor to provide a request for a service, wherein the request includes a type of service required and, preferred service provider, date, time, and location,
a geographical range location module configured to locate one or more service provider matching the request provided by the requestor within a particular area relative to the preferred location,
a broadcast module in communication with the geographical range location module configured to broadcast the request to the one or more service provider for a predefined time,
a request receiver module configured to display the broadcasted request to the service provider to accept or deny the request,
a collaboration module configured to connect a service provider and the requestor on acceptance of the request,
a rating module configured to enable the requestor to rate on the service provided by the service provider, and
a software engine is configured to process invoice for the service provided by the service provider; and
generating a home improvement, repairs, replacement, new addition, new build, residential or commercial project bid process in real time.

14. The system of claim 1, wherein
the residential or commercial project bid process homeowner or customers creates a project with the specific information, requirements, project details, project images, and other project related information;
the homeowner then picks the bid duration time;
the homeowner then adds important requirements proceeds to post the project for bid.

15. The system of claim 14, wherein
the home improvement, renovation, new build project with capability to post 360 degree panoramic images of the project,
where the project is going to be happen, and
what aspect of the project need to be done.

16. The system of claim 15, wherein
the in app 360 degree panoramic camera functionality built in the mobile app works in the way that when user initiates the image or video recorder the camera first sets 360 degree angle once angle is set the application lets the user know to move in a circle in either one direction;
the camera is then moved in rotation starting one point in a circle and coming back to same point same way to opposite direction or in other words the camera is started moving from one fix point and bringing back to same start point;
creating marks, text and edits on the 360 deg capture to explain where the repairs or replacement is required to be done.

17. The system of claim 14, wherein
to start the bid process for home improvement, by setting up a time to start and end the bid;
the service professionals/contractors would get in app and push notifications about when homeowner posts a project for bid;
the project with all details publish and appears on maps; and
the service provider when access the project it appears to be locked and they have to unlock to get full access to the project.

18. The system of claim 17, wherein
the bid starts with a minimum amount that the homeowner is willing to spent on the project;
the bidders won't be able to see the other bidders bid the bid displays the lowest value of the bid to the highest value in a leveled graph and chart;
only the one who created the project would be able to see the entire bid score;
the lowest bidder being the winner and highest bidder being not the winner;
the service providers or bidders would be able to see the number of bidders bidding on same project;
the bidders would also get the in app and push notification about someone unknown becoming higher bidder then them with disclosing the outbid amount;
the bidder cant increase the bid but can decrease the bid amount;
the bidders will have only one chance to enter the bid amount;
only the bidder would be able to see his bid amount, no other bidder would see the other bidders bid amount; and
once the bidder enter in bidding and placed a bid they can't back out and the bid amount they entered would stay in place.

19. The system of claim 18, wherein
once the bidder is outbid by other bidder the new bid amount updates instantly and in real time to homeowner and all bidders bidding on that project gets notification about they being out bided by someone;
the service providers can update their bid to stay above the other bidders; and
the homeowners and bidders get the in-app and push notification and all other means of notifications about the current status of bid, any new activity happens on bid in real time.

20. The system of claim 19, wherein
to create or post home improvement projects for a fixed or a variable price offer;
a customer or homeowner creates the project with an offer only option which means that one or more service professionals can submit an offer for the project;
the homeowner can either, accept, deny or counter the desired offer for the project;
the system will set the homeowners project for a certain time and after the time passes the project either ends or resets with all same terms on its self;
selecting an offer expiration time and date before submitting the offer; and
sending in app and push notifications to homeowner, service professionals about the changes made to offer, when it expires, how many other bidders are watching and showing interest to same project.
